(19) United States
(12) Patent Application Publication
(10) Pub. No.: US 2019/0236520 A1
(43) Pub. Date: Aug. 1, 2019

(54) MOVABLE BODY, SERVICE PROVIDING METHOD, STORAGE MEDIUM AND SERVICE PROVIDING SYSTEM

(71) Applicant: Toyota Jidosha Kabushiki Kaisha, Toyota-shi Aichi-ken (JP)

(72) Inventors: Yusuke Kaneko, Nagoya-shi Aichi-ken (JP); Masato Endo, Nagakute-shi Aichi-ken (JP); Shinji Sassa, Ama-shi Aichi-ken (JP); Takahiro Shiga, Chiryu-shi Aichi-ken (JP); Yohei Tanigawa, Toyota-shi Aichi-ken (JP)

(73) Assignee: Toyota Jidosha Kabushiki Kaisha, Toyota-shi Aichi-ken (JP)

(21) Appl. No.: 16/260,581

(22) Filed: Jan. 29, 2019

(30) Foreign Application Priority Data
Jan. 31, 2018 (JP) 2018-015007

(51) Int. Cl. G06Q 10/08; B60P 1/64

(52) U.S. Cl. CPC G06Q 10/083; B60P 1/6418

(57) ABSTRACT

A movable body that provides a service to a user, the movable body includes: a detection unit configured to detect the user who exists in a periphery of the movable body; an acquisition unit configured to acquire first information indicating a need of the user; and an output unit configured to output second information corresponding to the need.

### CROSS-REFERENCE TO RELATED APPLICATION

This application claims priority to Japanese Patent Application No. 2018-015007 filed on Jan. 31, 2018, incorporated herein by reference in its entirety.

### BACKGROUND

### 1. Technical Field

The disclosure relates to a movable body, a service providing method, a storage medium, and a service providing system.

### 2. Description of Related Art

In the related art, there have been proposed various delivery systems each of which delivers a parcel to a delivery destination. For example, there is a home delivery system including a plurality of home delivery box units, a delivery destination identifying unit that identifies a home delivery box unit corresponding to a delivery destination of a parcel from the plurality of home delivery box units based on the delivery destination of the parcel, and a movable body that delivers the parcel to a place where the identified home delivery box unit is installed, by automatic driving. In this home delivery system, the movable body includes an extension rail unit that extends toward an internal space region corresponding to the identified home delivery box unit, which is exposed by opening an opening-closing door, so as to form a bridge to the home delivery box unit, and a storage mechanism that stores the parcel delivered by the movable body through the extension rail unit, in the internal space region (for example, Japanese Patent No. 6164599).

### SUMMARY

Japanese Patent No. 6164599 discloses that the movable body moves to the place where the home delivery box unit is installed. Meanwhile, in some cases, the receiver (user) of the parcel wants to receive the parcel from the movable body, when the user is out. In this case, the user possibly hopes to acquire information for identifying a movable body on which the parcel as the receipt object has been loaded. Further, without being limited to the parcel delivery service, in the case where some kind of need is generated when the user is out, the user possibly hopes to acquire information corresponding to the need.

The disclosure provides a movable body, a service providing method of a movable body, and a storage medium with a program stored that allow the user to acquire the information corresponding to the need from the movable body.

A movable body according to a first aspect of the disclosure is a movable body that is able to provide a service corresponding to a need of a user. The movable body includes: a detection unit configured to detect the user who exists in a periphery of the movable body; an acquisition unit configured to acquire first information indicating a need of the user; and an output unit configured to output second information corresponding to the need.

According to the aspect, it is possible to acquire the information indicating the need of the user who exists in the periphery of the movable body, and to output the information corresponding to the need. Since the user acquires the information corresponding to the need, the user can easily receive a service corresponding to the need from the movable body.

In the above aspect, the output unit may be configured to output information indicating that an article has been loaded on the movable body, as the second information, when the first information indicates receipt of the article and the article has been loaded on the movable body. With the above configuration, the user can easily identify a movable body on which the delivery article as the receipt object has been loaded.

In the above aspect, the output unit may be configured to output information indicating that an article is able to be picked up, as the second information, when the first information indicates pickup of the article. With the above configuration, the user can easily identify a movable body that is used for the pickup.

In the above aspect, the output unit may be configured to output information by which the user is guided to a facility which is able to provide a predetermined service to the user, as the second information, when the first information indicates a demand for the predetermined service. With the above configuration, the movable body can function as a movable guide plate for the facility, and the user can easily visit the facility.

In the above aspect, the output unit may include a display device configured to display the second information, the display device existing at a position that allows the display device to be visually recognized from an outside of the movable body. With the above configuration, the user can obtain the information corresponding to the need, by referring to a display content of the display device of the movable body.

In the above aspect, the output unit may include a communication unit configured to send the second information to a terminal of the user. With the above configuration, the user can acquire the information corresponding to the need, from the user terminal in hand, even when the user cannot visually recognize the movable body.

In the above aspect, the movable body may further includes a movement control unit configured to move the movable body to a position where the service is provided to the user. With the above configuration, it is possible to provide the service to the user, at the position where the service is provided, and to enhance convenience for the user.

A service providing method of a movable body according to a second aspect of the disclosure includes: detecting the user who exists in a periphery of the movable body; acquiring first information indicating a need of the user; and outputting second information corresponding to the need.

A storage medium storing a program according to a third aspect of the disclosure, wherein the program makes a computer of a movable body that provides a service to a user, execute: detecting the user who exists in a periphery of the movable body; acquiring first information indicating a need of the user; and outputting second information corresponding to the need.

A service providing system according to a forth aspect of the disclosure includes: a movable body able to provide a service corresponding to a need of a user; and a management device for the movable body, wherein: the management device includes acquisition means configured to acquire first information indicating the need of the user, and supply means configured to supply the first information to the movable body; and the movable body includes a detection unit configured to detect the user who exists in a periphery of the movable body, an acquisition unit configured to acquire the first information from the management device, and an output unit configured to output second information corresponding to the need.

In the service providing system according to the disclosure, the management device may be configured to further include movement control means for supplying an instruction to the movable body that provides the service corresponding to the need, the instruction being an instruction of movement of the movable body to a stoppable position.

With the above aspects of the disclosure, the user can acquire the information corresponding to the need, from the movable body.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration diagram of a service providing system according to an embodiment;

FIG. 2 is a functional block diagram of the service providing system;

FIG. 3 shows an exemplary data structure of a table for movable body management information;

FIG. 4 shows an exemplary data structure of a table for user management information;

FIG. 5 is a flowchart showing an exemplary process of a movable body;

FIG. 6 is a flowchart showing an example of a receipt process for a delivery article;

FIG. 7 is a flowchart showing an example of a pickup process for the delivery article; and

FIG. 8 is a flowchart showing an exemplary process for provision of information corresponding to a need.

### DETAILED DESCRIPTION

Hereinafter, a movable body, a service providing system, a service providing method and a program stored in a storage medium according to an embodiment of the disclosure will be described with reference to the drawings. The configuration of the embodiment is an example, and the disclosure is not limited to the configuration of the embodiment.

Overview of System

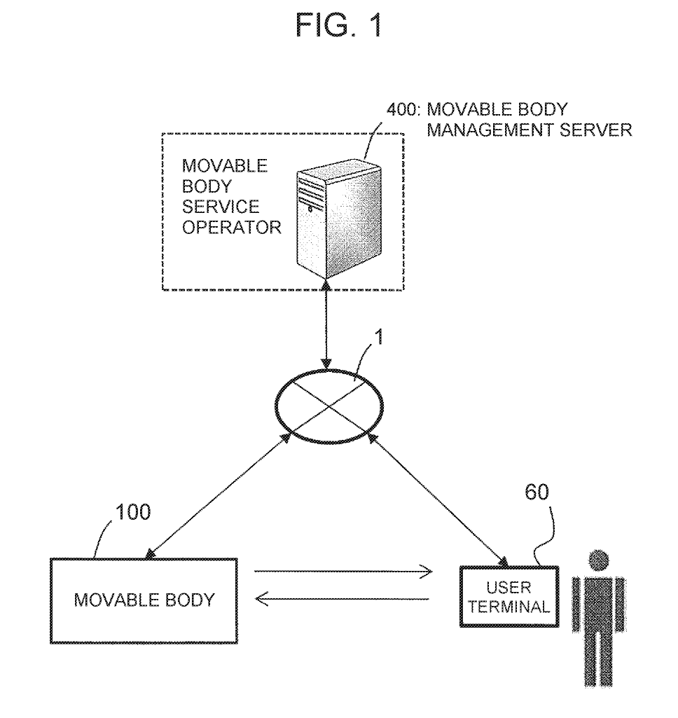

FIG. 1 is a schematic diagram a service providing system according to an embodiment. In FIG. 1, the service providing system includes a user terminal 60, a movable body 100 and a movable body management server 400 (also referred to as a management server 400), which are communicably connected to a network 1. A “management device for the movable body” is an example of the management server 400. A “movable body able to provide a service corresponding to a need of a user” is an example of the movable body 100.

For example, the network 1 is a public communication network such as the internet, and a wide area network (WAN) and other communication networks can be employed. The network 1 may include a cellular network such as Long Term Evolution (LTE) and a wireless network such as a wireless local area network (LAN: Wi-Fi® or the like). The movable body 100 and the user terminal 60 may directly communicate with each other, based on a short-range communication standard such as Bluetooth®, BLE (Bluetooth® Low Energy) and ZigBee®, without a relay (a base station, an access point or the like).

The management server 400 performs processes for operation of the service providing system using the movable body 100. As processes for the operation of the service provision system, the management server 400 performs various processes including a process for management of the movable body 100, as exemplified by an issuance of a command to the movable body 100, and a process for management of a user who receives provision of a service by the service providing system.

The management server 400 manages information about the movable body 100 (for example, information indicating the current position of the movable body 100, information indicating status (state) of the movable body 100, information indicating an operation schedule, and information indicating whether there is a parcel). Further, the management server 400 manages information about the user (a member of the service providing system) who receives the service through the service providing system.

The management server 400 receives information indicating a need of the user, from the user terminal 60 or the like, and holds the received information. The information indicating the need of the user may be stored in the management server 400, or may be stored in a place (another database server or an external storage device) other than the management server 400. The management server 400 gives information indicating the need or information corresponding to the need, to the movable body 100 that finds (detects) the user. The information corresponding to the need may include an instruction about provision of the service or a command about movement of the movable body 100.

The movable body 100 is a vehicle that receives a command from the management server 400 and performs autonomous traveling. The movable body 100 has a space (also referred to as a storing space or a loading place) for storing or loading a parcel or passenger. The movable body 100 stores a parcel passed over from a delivery business operator or the like, and brings the parcel to the user, or the movable body 100 stores a parcel picked up from the user. In some cases, the movable body 100 functions as a transport apparatus for a human or an animal.

Some movable bodies 100 function as a shop (for example, a restaurant, a store or a showcase), a business location of a business operator (for example, a private office or a business site), or a public facility (for example, a city office, a library or a medical facility). The movable body 100 can provide various services corresponding to needs of the user. The service includes transport of a parcel or passenger, delivery of an article, pickup of an article, transfer of an article, exhibition of an article, rental of an article, rental of a workspace, acceptance of various applications, and the like. The content of the service is not limited to them. The article includes a parcel as an object of transport, delivery or pickup, a product (including a product to be provided in association with service provision) as an object of a business dealing, and the like. It does not matter whether the article is an object of a business dealing, and it does not matter whether the article is charge-free.

The user terminal 60 is a terminal of the user, and is used mainly for registration of the information indicating the need in the management server 400 by the user or for transmission or notification of the information corresponding to the need to the user. The user terminal 60 has a function to communicate through the network 1 or a function to directly communicate with the movable body 100.

For example, the user terminal 60 is a smart device (a smartphone, a smartwatch, a tablet terminal or a wearable terminal), a terminal (referred to as a portable terminal) having portability, as exemplified by a personal computer (PC), or an in-vehicle terminal. The user terminal 60 is not limited to the above terminals, and a dedicated or general-purpose terminal allowing later-described processes and actions can be applied to the user terminal 60.

In the embodiment, as an example, a single or a plurality of movable bodies 100 is disposed for each region (also referred to as an area), and the management server 400 manages the operation of the movable body 100 disposed for each area. The area may be an administrative district, or may be a geographical range that is appropriately determined by a movable body management business operator. The comparting method for the area can be appropriately selected. The largeness of the area is determined based on an occupant distribution. For example, for densely populated areas, small areas are set, and for sparsely populated areas, large areas are set. The largeness of the area may be set in accordance with another basis.

The movable body 100, which goes round in the area, is operated while the movable body 100 is shared by a plurality of users existing in the area. That is, the movable body 100 that provides the service corresponding to the need of the user is identified, and the movable body 100 moves to a service provision position in the vicinity of the user, and provides the service corresponding to the need.

A route (path) along which the movable body 100 goes round in the area can be appropriately set. In the area, one or more base points (stop places for the movable body 100) are provided. The movable body 100 departs from a base point that is a start point, makes a round of the area along a predetermined route, and returns to the base point. In the case where there is a plurality of (two or more) base points in the area, the movable body 100 departs from a first base point, goes through other base points in a predetermined order, and returns to the first base point. However, the movable body 100 may go along a different route for each round. Further, in one round, a base point as a start point of the movement of the movable body 100 and a base point as an end point of the movement may be different from each other. The plurality of movable bodies 100 may go round along the same route, or may go round along different routes. Although not illustrated, in the embodiment, as an example, the movable bodies 100 move in the same direction along a single round route connecting the base points, with a time lag.

As an example, the movable body 100 stops at each base point, and after a predetermined time, starts to move toward the next destination. At least at one base point, energy resupply (charge, fuel supply or the like) is performed to the movable body 100. For example, in the case where the movable body 100 is electrically driven, the charge of a secondary battery of the movable body 100 is performed at the base point. The base point may include a parking lot of a convenience store, a business site of a vehicle dealer, a repair shop for a vehicle, and the like, and may be any place if there is a space where the movable body 100 is at a stop for predetermined time.

As an example, the delivery business operator for the parcel loads the parcel on the loading place of the movable body 100 stopped at the base point. The delivery business operator may call the movable body 100 to a delivery center, to load the parcel. Alternatively, the delivery operator may stop the movable body 100 that moves toward the next destination, to load the parcel.

The movable body 100 starts to move toward the next destination, for example, when a movement start time has come at the base point where the movable body 100 is at a stop. On this occasion, in the case where there is a loaded parcel, it is determined that the next destination is the delivery destination of the parcel, and the movable body 100 starts the autonomous driving toward the delivery destination. In the case where there is no loaded parcel, it is determined that the next destination is the next base position. The determination of the destination is performed, for example, based on a command from the management server 400. Alternatively, the determination of the destination may be autonomously by the movable body 100, using information indicating whether there is a parcel and information indicating the delivery destination of the parcel.

The movable body 100 searches a user who exists in a periphery of the movable body 100 (in a predetermined range around the movable body 100). The search may be performed while the movable body 100 is at a stop, or may be performed while the movable body 100 is moving. The search of the user is performed by the movable body 100, for example, by photographing the surround of the movable body 100 using a camera 106, acquiring biological information of a human (for example, a face image of the human) and determining whether the human is the user.

Alternatively, for the search of the user, the existence of the user may be detected when the movable body 100 sends a search signal for the user terminal 60, as exemplified by a beacon, and the movable body 100 receives an answer signal sent by the user terminal 60 in response to the search signal. For example, it may be determined that the user exists in the periphery of the movable body 100, when identification information (user ID: the user ID may be a user's own ID or may be an ID of the user terminal of the user) of the user included in the answer signal matches with a user ID in the service providing system.

The sending and receiving of the search signal and the answer signal may be directly performed between the movable body 100 and the user terminal 60, or may be performed through the network 1. Thus, a geographical range where the face of a human allowing face recognition can be photographed from the movable body 100, or a geographical range where the user terminal 60 can receive the search signal from the movable body 100 is an example of “periphery of the movable body 100 (a predetermined range around the movable body 100)”.

Examples of the need include receipt of an article (a parcel or a product), pickup of a parcel, provision of the information corresponding to the need, movement assist (transport) to a predetermined place, or the like. Examples of the information indicating the need include “a wish for receipt of an article (a parcel or a product)”, “a wish for pickup of a delivery request article”, and “a demand for a predetermined service”. The demand for a predetermined service includes “a wish for purchase of a product”, “a wish for provision of food and drink”, “a wish for provision of a predetermined service (work)”, and the like.

Examples of the information corresponding to the need include information indicating that an article as a receipt object for the user has been loaded on the movable body 100, information indicating that an article as a pickup object is able to be picked up, information by which the user is guided to a facility where the user is able to enjoy a desired service.

The facility is a shop, a business office, a business site or the like for sale of a product that the user hopes to purchase or provision of a service that the user hopes to enjoy, and may be a shop, a business office, a business site or the like that is fixed, or may be the movable body 100 that has a function as a shop, a business office, a business site or the like.

When the movable body 100 detects the user who exists in the periphery of the movable body 100, the movable body 100 acquires the information indicating the need of the user. For example, the movable body 100 acquires the information indicating the need, by inquiring of the management server 400 about whether there is the need of the user. Alternatively, the management server 400 manages the information indicating the need and the information indicating the current position of the user, and sends the user ID and the information indicating the need of the user, to each of the movable bodies 100 that exist in a predetermined range around the current position. By employing this configuration, the movable body 100 may acquire the information indicating the need of the user, regardless of whether the user is detected.

In the case where the information indicating the need exists (the need exists), the management server 400 outputs (gives a notice) the information corresponding to the need, to the detected user. For the output (notice), the movable body 100 displays the information corresponding to the need, on a display device (a display monitor 107) of the movable body 100, or sends the information corresponding to the need, to the user terminal 60.

The user terminal 60 displays the information corresponding to the need, on a display monitor of the user terminal 60. The user can know the information corresponding to the need, by referring to the display monitor of the movable body 100 or the display monitor of the user terminal 60.

For service provision, the movable body 100 moves to a stoppable position of the movable body 100 that is in the vicinity of the user or near the user, and stops to provide the service. The stoppable position is a position (service provision position) where the service is provided. For example, if the need is “receipt of an article”, the movable body 100 adopts the stoppable position near the user, as the service provision position, that is, as an article transfer position (article receipt position), and moves the position, to stop at the position. The user performs the receipt of the parcel by taking the parcel from the article loading place in the movable body 100 stopped at the transfer position.

If the need is “pickup of an article”, the movable body 100 adopts the stoppable position near the user, as the service provision position, that is, as a pickup position (transfer position), and moves to the position, to stop at the position. The user puts (or stores) the parcel on the loading place in the stopped movable body 100, so that the transfer (pickup) of the parcel is performed.

For example, if the need is “acquisition of an article (for example, food and drink)”, the movable body 100 adopts the stoppable position near the user, as the service provision position, that is, as the provision place for the information corresponding to the need, and moves to the position, to stop at the position. The movable body 100 displays information about the place of a facility (a fixed shop or the movable body 100) allowing purchase of the food and drink or allowing eating and drinking of the food and drink and information for course guide (an address, a telephone number, a map and the like), on the display monitor 107.

The provision of the service may be performed in cooperation, by a plurality of movable bodies 100. For example, in the case of the course guide to a shop, a plurality of movable bodies 100 may stop at positions allowing the user to visually recognize the movable bodies 100, on a path from the position of the user to a facility or along the path, and each movable body 100 may display the information for course guide on the display monitor (displays a guide plate). Alternatively, each of the plurality of movable bodies 100 may lead the user or convey the user in a predetermined range of the path.

The information indicating the service provision position may be displayed on the display monitor 107 of the movable body 100, or may be sent to the user terminal 60, to be displayed on the display monitor of the user terminal 60. By the display on the user terminal 60, the user can move to the service provision position even when the user cannot visually recognize the movable body 100. It is only necessary to perform at least one of displaying the information on the display monitor 107 and sending the information to the user terminal 60. Both of displaying the information on the display monitor 107 and sending the information to the user terminal 60 may be performed.

A series of processes from the search of the user to the provision of the service may be performed while the movable body 100 is at a stop. For example, in the case where the user is detected from the image photographed by the camera 106 of the movable body 100 stopped at the base point, the information corresponding to the need and including information that indicates the position of the base point as the service provision position may be sent to the user terminal 60, or may be displayed on the display monitor 107.

Thus, as long as the movable body 100 stops at the stoppable position, the movable body 100 may stop in the vicinity of the position of the user, or may designate a position near the position of the user or a stop position of the movable body 100, as the service provision position, and may wait for the user at the position.

When the provision of the service is completed, the movable body 100 receives a command to move to the next destination, from the management server 400, and restarts the movement. In the case where a plurality of users having needs exists in the periphery of the movable body 100, one user is identified from the plurality of users by a predetermined method, and the service is provided to this user. Examples of the predetermined method include a method of selecting the user in an order in which the need is registered or in an order from a highest priority level set for the user. However, the user may be randomly selected.

System Configuration

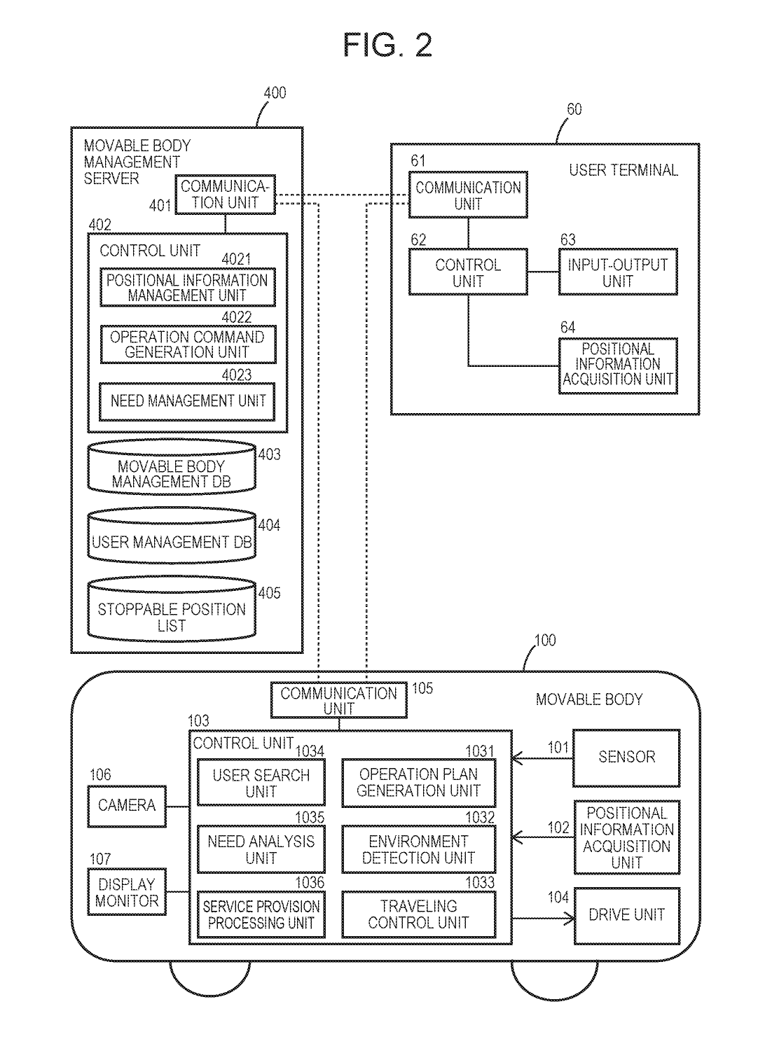

FIG. 2 is a configuration diagram schematically illustrating respective configurations of the movable body 100, the management server 400 and the user terminal 60. Hardware configurations and functional configurations of the movable body 100, the management server 400 and the user terminal 60 according to the embodiment will be described based on FIG. 2. In FIG. 2, the network 1 is not illustrated.

Movable Body

The movable body 100 goes round in the area along a predetermined route, based on a command from the management server 400. The movable body 100 searches the user who exists in the periphery, while going round. When the user is detected, the movable body 100 checks whether the user has a need. In the case where the user has a need, the movable body 100 outputs the information corresponding to the need.

The movable body 100 does not always need to be a driverless movable body, and the autonomous traveling is not an essential requirement. For example, a staff to provide the service to the user, a maintenance staff (who performs a charge work and the like at the base point) or the like may be in the movable body 100. The movable body 100 does not always perform the autonomous movement constantly. For example, the movement may be performed by human's handling. The handling may be a handling within the movable body 100, or may be a remote manipulation using a remote controller or the like. In the embodiment, a case where the movable body 100 is a vehicle that performs the autonomous traveling on a road will be described.

The movable body 100 travels in accordance with an operation command (corresponding to a movement instruction) acquired from the management server 400. Specifically, the movable body 100 generates a traveling path based on the operation command acquired through wireless communication, and travels on the road by an appropriate method as the autonomous traveling, while sensing the surround of the vehicle. As an example, the movable body 100 is configured to include a sensor 101, a positional information acquisition unit 102, a control unit 103, a drive unit 104, a communication unit 105, the camera 106, and the display monitor 107. The movable body 100 is equipped with an unillustrated battery (secondary battery), and the movable body 100 acts with electric power to be supplied from the secondary battery.

The sensor 101 senses the surround of the movable body 100 for acquiring information necessary for the autonomous traveling of the movable body 100. Examples of the sensor 101 include a stereo camera, a laser scanner, a LIDAR and a radar. The information acquired by the sensor 101 is sent to the control unit 103, and is used by the control unit 103, for example, for recognition of an obstacle existing around the movable body 100 and a traveling lane.

The positional information acquisition unit 102 acquires the current position of the movable body 100. For example, the positional information acquisition unit 102 is configured to include a global positioning system (GPS) receiver and the like. The information acquired by the positional information acquisition unit 102 is also sent to the control unit 103, and is used for predetermined processes, as exemplified by calculation of a route for the movable body 100 to arrive at the destination using the current position of the movable body 100, and calculation of a time required for arrival at the destination.

The control unit 103 is a computer that controls the movable body 100 based on the information acquired from the sensor 101 and the positional information acquisition unit 102. Although not illustrated, the control unit 103, for example, includes a processor such as a central processing unit (CPU), and a storage unit including a memory and an auxiliary storage device (a hard disk or the like). The CPU loads programs stored in the auxiliary storage device, in the memory, and executes the programs, so that functions for the above various processes are realized. As specific examples of the various processes, the control unit 103 acts as an operation plan generation unit 1031, an environment detection unit 1032, a traveling control unit 1033, a user search unit 1034, a need analysis unit 1035, and a service provision processing unit 1036.

The operation plan generation unit 1031 acquires the operation command from the management server 400, and generates an operation plan for the movable body 100. The operation command includes information that is relevant to a departure place and a destination and that is given to the movable body 100. Accordingly, the operation plan generation unit 1031 calculates a movement route for the movable body 100 and generates an operation plan for moving along the movement route, based on the destination given from the management server 400 and the current position obtained by the positional information acquisition unit 102. The operation plan includes data relevant to the thus calculated path along which the movable body 100 travels, and data specifying a process that the movable body 100 should perform on a part or a whole of the path. Examples of the data included in the operation plan include the following (1) and (2).

(1) Data expressing the traveling path for the movable body 100 as an aggregation of road links, for example, by referring to stored map data, the traveling path for the movable body 100 may be automatically generated based on the given departure place and destination. The calculation of the traveling route for the movable body 100 may be depend on processing of an external device (for example, the management server 400), instead of being performed in the movable body 100. In this case, the management server 400 acquires the current position from the movable body 100, and calculates the path along which the movable body 100 goes. The calculated path data may be included in the above operation command, or may be separately sent to the movable body 100.

(2) Data expressing a process to be performed by the movable body 100 on the path, for example, includes “search of the user”, “analysis of the need of the user”, “output of the information corresponding to the need (change in the display content of the display monitor)”, and “provision of the service corresponding to the need”, but is not limited to them. The operation plan generated by the operation plan generation unit 1031 is sent to the traveling control unit 1033 described later.

The environment detection unit 1032 detects an environment around the movable body 100 that is necessary for the autonomous traveling, based on the data acquired by the sensor 101. The object of the detection, for example, includes the number and positions of lanes, the number and positions of other movable bodies existing around the movable body 100, the number and positions of obstacles (for example, pedestrians, bicycles, structures and buildings) existing around the movable body 100, the structures of roads, and traffic signs, but is not limited to them. The object of the detection may be any object if the object is needed for the autonomous traveling. For example, in the case where the sensor 101 is a stereo camera, image data captured by the stereo camera is processed, and thereby, the detection of physical objects around the movable body 100 is performed.

In addition to the detection of physical objects around the movable body 100, the environment detection unit 1032 may perform tracking of the detected physical object (detecting the detected object continuously). For example, the relative speed of the physical object can be evaluated from the difference between the coordinates of the physical object detected in the last step and the current coordinates of the physical object. The data (hereinafter, referred to as environment data) that is relevant to the environment around the movable body 100 and that is detected by the environment detection unit 1032 is sent to the traveling control unit 1033 described later.

The traveling control unit 1033 generates a control command for controlling the autonomous traveling of the movable body 100, based on the operation plan generated by the operation plan generation unit 1031, the environment data generated by the environment detection unit 1032 and the positional information of the movable body 100 acquired by the positional information acquisition unit 102. For example, the traveling control unit 1033 generates the control command, in order for the movable body 100 to travel such that the movable body 100 travels along a predetermined path and the obstacle does not enter a predetermined safety region around the movable body 100. The generated control command is sent to the drive unit 104 described later. As a control command generation method for the autonomous movement of the movable body 100, a known method can be employed.

The drive unit 104 is means for making the movable body 100 travel based on the control command generated by the traveling control unit 1033. For example, the drive unit 104 is configured to include a motor for driving wheels of the movable body 100, an inverter, a brake, a steering mechanism and the like. The motor, the brake and the like are driven in accordance with the control command, and thereby, the autonomous traveling of the movable body 100 is realized.

The communication unit 105 connects the movable body 100 to the network 1. As the communication unit 105, an network interface card (NIC; not illustrated) or the like is applied. In the embodiment, the communication unit 105 can perform communication with another device (for example, the management server 400) via the network 1, using a mobile communication service with 3rd Generation (3G), Long Term Evolution (LTE) or the like. The communication unit 105 may be configured to further perform communication with the user terminal 60 based on a short-range wireless communication standard such as BLE.

The camera 106 is a visible light camera, for example, and photographs an image or moving image of the surround of the movable body 100, for detecting the user who exists in the periphery of the movable body 100 by a face recognition process. The image may be a color image, or may be a black-and-white image. The movable body 100 is provided with a single or an appropriate number of cameras 106 such that a predetermined range from the movable body 100, for example, a forward view, a rearward view and lateral views of the movable body 100 can be photographed. The cameras 106 may be attached to outer walls (a front surface, a back surface, lateral surfaces, a top surface and the like) of the movable body 100, or may be attached in the interior of the movable body 100 so as to photograph the surround of the movable body 100 through windows.

The display monitor 107 is provided on at least one of a front wall, a back wall and lateral walls of the outer walls of the movable body 100. However, the display monitor 107 may be provided in the interior of the movable body 100 such that a display surface can be visually recognized from the exterior through a window. On the display monitor 107, an advertisement and the information corresponding to the need of the user are displayed. Examples of the information corresponding to the need include information indicating the delivery or pickup of the parcel and information (for example, a course guide to a shop) to be provided to the user. The information indicating a notice content can be appropriately set depending on the need and the content of the service to be provided to the user corresponding to the need.

The display monitor 107 may be a liquid display (LCD), a plasma display or an organic EL display, or may be a display device in which a plurality of LEDs or lamps is arrayed and is used as pixels. The information corresponding to the need may be output by display of a text or figure, display of a color, voice output, lighting-blinking or the like. Thereby, the movable body 100 may be configured to include a speaker, a lamp or the like, in addition to the display monitor 107 or instead of the display monitor 107.

The control unit 103 acts as the user search unit 1034, the need analysis unit 1035 and the service provision processing unit 1036, by execution of programs. The user search unit 1034 searches the user who exists in the periphery of the movable body 100. In the search, the user search unit 1034 extracts the face of a human from the image of the surround of the movable body 100 that is photographed by the camera 106, compares features of the extracted face and features of the face of the user, and determines whether the face of the human is the face of the user. In the case where the face of the human is the face of the user, the user search unit 1034 detects the user having the face, as the user who exists in the periphery of the movable body 100.

As a technique for the face recognition process, all existing techniques can be applied. Data (face information) indicating the features of the face of the user may be previously stored in the movable body 100. Alternatively, whenever the search is performed, the face information may be requested to the management server 400, and the face information to be provided from the management server 400 may be acquired by the movable body 100. In this case, the management server 400 may extract the face information of users for which the distance from the current position of the movable body 100 is in a predetermined range, from an aggregation (population) of the face information of users, and may provide the extracted face information to the movable body 100. The providing source of the face information may be a device other than the management server 400. Further, the face recognition process may be performed by a device other than the movable body 100, and the result of the face recognition process may be received by the movable body 100 (user search unit 1034).

The user search unit 1034 may employ the following configuration. That is, the user search unit 1034 controls the communication unit 105, to send a search signal toward the user terminal 60 that exists in the periphery of the movable body 100, and in the case where an answer signal to the search signal is received and the user ID (or the user terminal ID of the user terminal 60 of the user) is included in the answer signal, the user search unit 1034 detects the user corresponding to the user ID as the user who exists in the periphery of the movable body 100.

The need analysis unit 1035 determines whether the need has been registered, for the user detected (found) by the user search unit 1034. For example, the management server 400 receives the information indicating the need of the user, from the user terminal 60, and registers the received information in a user management DB 404. The need analysis unit 1035 inquires of the management server 400 about whether there is the need of the found user (whether the information about the need has been registered in the user management DB 404). In the case where the information about the need has been registered, the information about the need or a provision instruction for the service corresponding to the need is sent from the management server 400, and is given to the service provision processing unit 1036 through the communication unit 105.

The following configuration may be also employed. That is, local data of the user management DB 404 (a copy of the user management DB 404 in the management server 400) is stored in a storage unit of the control unit 103, and synchronization is performed at an appropriate timing. Instead of the above inquiry, the need analysis unit 1035 reads the information about the need, from the user management DB stored in the local, generates information corresponding to the provision instruction for the service as necessary, and supplies the information about the need and the information corresponding to the provision instruction for the service, to the service provision processing unit 1036.

The service provision processing unit 1036 performs a process to output the information corresponding to the need, in response to the information about the need or the provision instruction for the service corresponding to the need. For example, the service provision processing unit 1036 causes output device, for example, the display monitor 107 or the communication unit 105, to output the information corresponding to the need. Especially, in the case where the need is “receipt of an article”, the service provision processing unit 1036 performs a process to display information indicating that the article is being delivered, which is the information corresponding to the need, on the display monitor 107, or a process to send the information indicating that the article is being delivered to the user terminal 60 using the communication unit 105. In the case where the need is “pickup of an article”, the service provision processing unit 1036 performs a process to display information indicating that the movable body 100 is on the way for the pickup of the article, which is the information corresponding to the need, on the display monitor 107, or a process to send the information indicating that the movable body 100 is on the way for the pickup of the article to the user terminal 60 using the communication unit 105. For example, in the case where the need is “acquisition of an article (for example, a wish to eat pizza)”, the service provision processing unit 1036 performs a process to generate information indicating a path to a shop to sell pizza (the movable body 100 that functions as a movable shop to sell pizza), as the information corresponding to the need, and displays the generated information on the display monitor 107 or sends the generated information to the user terminal 60.

In addition to the information corresponding to the need, the service provision processing unit 1036 displays information indicating the stoppable position (service provision position) of the movable body 100, on the display monitor 107, or sends the information to the user terminal 60. The user can come close to the movable body 100 stopped at the stoppable position, by reference to the information indicating the stoppable position, and can enjoy the provision of the service (the receipt of the article, the transfer of the article, or the presentation of information about the guide to the shop).

As the stoppable position, a list (not illustrated) of places (parking lots and the like) allowing the safety of the movable body 100 to be secured and allowing traffic not to be hindered is previously registered in the management server 400. For example, a stoppable position closest to the current position of the user is extracted from the list, and is adopted as the service provision position. Further, for example, in the case where the current position of the user is contained in a broad stoppable position (the whole of a predetermined range around the user is a stoppable position), the movable body 100 may stop in front of or beside the user while the safety of the surround and a sufficient distance from the user are secured.

The user search unit 1034 is an example of the detection unit. The need analysis unit 1035 is an example of the acquisition unit. The display monitor 107 is an example of the output unit, and the communication unit 105 is another example of the output unit. A set of the functions of the operation plan generation unit 1031, the environment detection unit 1032 and the traveling control unit 1033 is an example of the movement control unit. The set of functions are realized by the control unit 103.

Movable Body Management Server

Next, the management server 400 will be described. The management server 400 is a device that manages the autonomous traveling of a plurality of movable bodies 100 and sends operation commands. The management server 400 has information indicating a schedule with which the movable body 100 moves along the round route, and based on this information, generates operation commands to give instructions of a predetermined time stop at a base point and the movement to the next destination, to give the operation commands to the movable body 100.

In the case where the management server 400 receives a delivery request or pickup request for the parcel as the information indicating the need of the user, the management server 400 acquires the delivery position or pickup position (designated position) designated by the user in the delivery request or the pickup request, and then, sends an operation command to move to the delivery position or the pickup position, to the movable body 100 that is traveling in the vicinity. Furthermore, in response to the inquiry from the movable body 100 that has detected the user, the management server 400 sends the information indicating the corresponding need or the provision instruction for the service corresponding to the need, to the movable body 100.

The management server 400 has a general computer configuration. Specifically, the management server 400 includes a processor (not illustrated) such as a CPU and a digital signal processor (DSP), a memory (not illustrated) such as a random access memory (RAM) and a read only memory (ROM), and an auxiliary storage device (not illustrated) such as an erasable programmable ROM (EPROM), a hard disk drive (HDD) and a removable medium. For example, the removable medium is a universal serial bus (USB) memory, or a disc recording medium such as a compact disc (CD) and a digital versatile disc (DVD). In the auxiliary storage device, an operating system (OS), various programs, various tables and the like are stored. The processor loads the programs stored in the auxiliary storage device, in a working area of the memory. By the execution of the programs, various processes and actions are performed, and thereby, functions matching with predetermined purposes can be realized.

The management server 400 includes a communication unit 401. The communication unit 401, which is connected to another device through the network 1, performs communication with the movable body 100, the management server 400 and the like. For example, the communication unit 401 is an NIC or a wireless communication circuit for wireless communication. The NIC or the wireless communication circuit is connected to the network 1.

Furthermore, in the auxiliary storage device, the management server 400 includes a movable body management DB 403 in which a variety of information relevant to a plurality of movable bodies 100 to perform the autonomous traveling is stored. The database (DB) is built when a program for a database management system (DBMS) that is executed by the processor manages the data stored in the auxiliary storage device. For example, the movable body management DB 403 is a relational database.

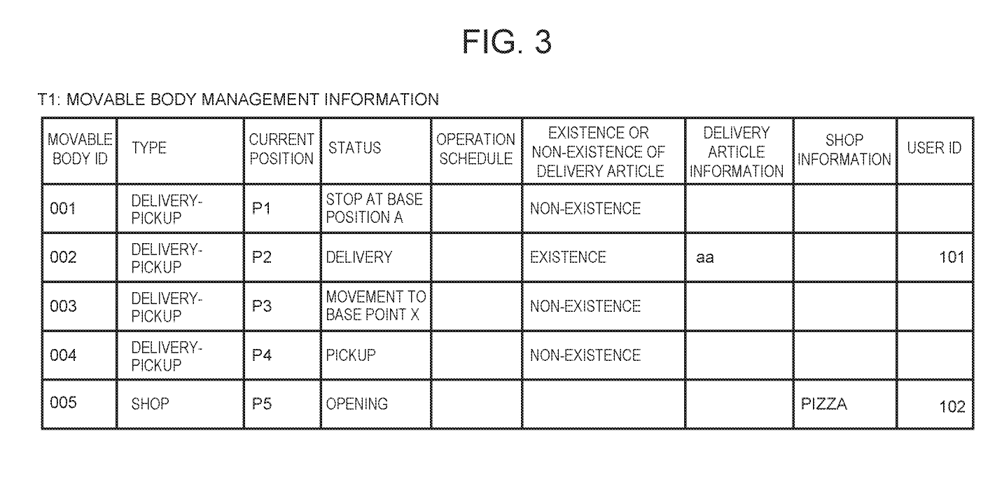

Here, the configuration of movable body management information stored in the movable body management DB 403 will be described based on FIG. 3. FIG. 3 shows an exemplary data structure of a table T1 in which the movable body management information is stored. The table T1 has a record (entry) for each movable body ID, and each record has fields for the type of the movable body 100, the current position of the movable body 100, the status of the movable body 100, the operation schedule of the movable body 100, the existence or non-existence of the delivery article (the parcel, the product or the like that is a delivery object), and delivery article information, which are correspond to the movable body ID.

In the field for the type, information indicating a type based on purpose of use of the movable body 100 is stored. In the example of FIG. 3, a type “DELIVERY-PICKUP” and a type “SHOP” are shown. “DELIVERY-PICKUP” means the movable body 100 that moves in the area for the purpose of the delivery or pickup of the delivery article. “SHOP” means the movable body 100 that functions as a shop, a business office, a business site or the like for performing the sale, exhibition or rental of a predetermined article (product) or the provision of a service. “SHOP” may be subdivided depending on the content of the product or service to be handled.

In the field for “CURRENT POSITION”, the current position of the movable body 100 that is acquired by the movable body 100 is stored, and for example, is information relevant to the latitude and longitude for identifying the current position of the movable body 100. The field of the current position of the movable body 100 in the movable body management DB 403 is updated, whenever the information acquired by the positional information acquisition unit 102 of the movable body 100 is sent from the movable body 100 to the management server 400. However, the current position may be acquired from other than the movable body 100.

The status indicates the current state of the movable body 100. Examples of the status include “STOP” at a predetermined base point, “DELIVERY” meaning a movement to a delivery position (service provision position) or a stop at a delivery position, “MOVEMENT” to the next destination, and “PICKUP” meaning a movement to a pickup position (service provision position) or a stop at a pickup position. The movable body 100 sometimes presents the information corresponding to the need, and in this case, the status is “INFORMATION PRESENTATION”. Other states (“INSPECTION”, “SUSPENSION (NON-OPERATING STATE)”) may be included. The class of the status is not limited to them. The status of the movable body 100 that is a shop can be expressed as opening, closing (a movement outside business hours or a stop at a place other than opening places), and the like.

The operation schedule means the operation schedule for the movable body 100. For example, the schedule is formed by stop times at base points, movement start times at base points and the like. In the embodiment, the management server 400 instructs the movable body 100 to perform the stop at the base point or the movement to the next destination (for example, the delivery position, the pickup position and the base point), as an operation command according to the operation schedule information. The management server 400 gives an instruction to stop at the base point for a predetermined time when the movable body 100 arrives at the base point, and issues an operation command to move to the next destination when a departure time to the next destination comes. The next destination is changed to a delivery position or a pickup position depending on the delivery request or the pickup request. When the delivery or the pickup is completed, the management server 400 issues an operation command in which the next destination is the next base point, if there is not another delivery request or pickup request. For the movable body 100 that is a shop, the management server 400 controls the movement to an opening position of the shop, the stop (business) at the opening position, and the movement from the opening position to a position (a predetermined base point) at a closing time, by issuing an operation command in accordance with the operation schedule for the shop.

The existence or non-existence of the delivery article means whether the delivery article such as the parcel or the product has been loaded on the movable body 100. As the delivery article information, the information about the delivery, as exemplified by a delivery article ID that is an identifier of the delivery article or a management number (delivery ID) for delivery work, the content of the delivery article, information indicating a delivery destination and a desired delivery time, is stored. The shop information includes information such as the content of the product or service to be handled in the shop, the opening position of the shop, and business hours. Further, in the table T1, the user ID of a user who is a receiver of the delivery article is stored in association with the movable body ID. Further, in the table T1, as the information corresponding to the need, the user ID of a user who receives the presentation of the information about the shop (the information indicating the path to the shop, or the like) is stored in association with the movable body ID.

For information about fixed shops that is presented to the user, information such as shop names, products or services to be handled, business hours and shop positions may be managed in a separate table (not illustrated) from the table T1. The fixed shop may be retrieved using a search engine, whenever the need is generated.

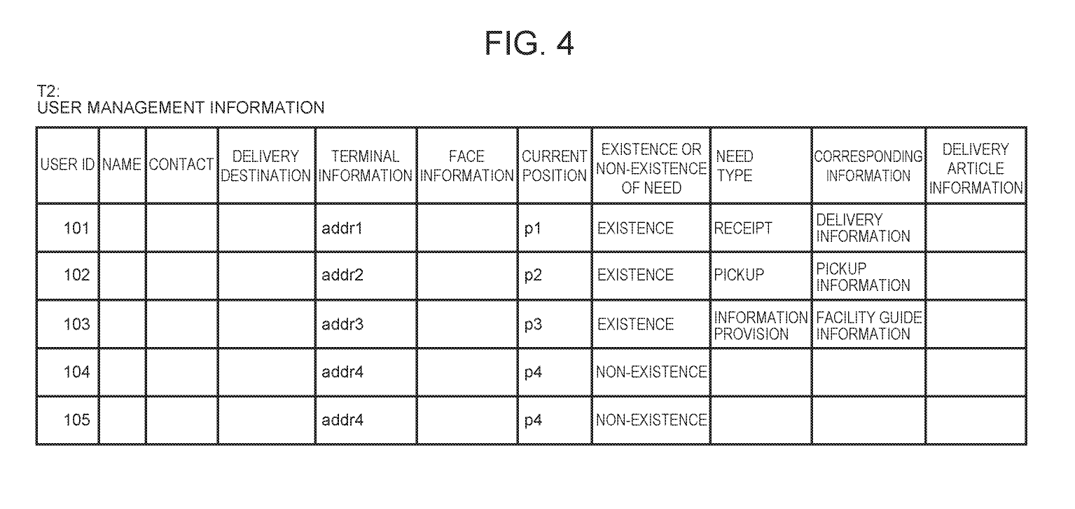

Further, the user management DB 404 is stored in the auxiliary storage device. FIG. 4 shows an exemplary data structure of a table T2 for user management information that is stored in the user management DB 404. The table T2 is formed as an aggregation of a record for each user ID that is an identifier of the user. The record has fields for storing the name (or business name) of the user, contact information, delivery destination information, terminal information, face information, current position, the existence or non-existence of the need, the type of the need, need-corresponding information, and delivery article information.

As the contact information, information indicating the address, telephone number, mail address and others of the user is stored. As the delivery destination information, information indicating a delivery destination of the parcel that is different from the address is stored. As the face information, information indicating the features of the face of the user that are used for the face recognition is stored. The terminal information indicates an address that is used for sending data to the user terminal 60. For example, the address is an internet protocol (IP) address or a media access control (MAC) address.

As the current position, information indicating the current position of the user is stored. As the existence or non-existence of the need, when there is a delivery request or pickup request from the user, “EXISTENCE” of the need is recorded, and when the delivery or the pickup is completed, “NON-EXISTENCE” is recorded. The need type is the information indicating the need, and includes the receipt of the delivery article, the pickup of the delivery article, the information provision indicating the provision of the information about the shop (facility) where the product or service is provided, and the like. The corresponding information is the information corresponding to the need, and the information to be displayed in the display monitor 107 or to be sent to the user terminal 60 is stored. Further, in the table T2, information about the delivery article for which the user requests the delivery is stored as the delivery article information. The delivery article information includes the movable body ID of the movable body 100 on which the delivery article has been loaded.

A stoppable position list 405 is a list that is stored in the auxiliary storage device of the management server 400 and that indicates positions where the movable body 100 can stop in the area. In the embodiment, the movable body 100 stops at the stoppable position determined based on the stoppable position list 405. However, it is allowable to employ a configuration in which the movable body 100 itself autonomously determines a stoppable position where the safety and the traffic are not hindered securely, using the sensor 101 and the camera 106, and stops at the stoppable position.

In the management server 400, the above-described processor executes programs, so that a control unit 402 is formed as a function unit. As described above, the control unit 402 performs processes relevant to the autonomous traveling of the movable body 100, and communication with the movable body 100, the user terminal 60 and the like. More specifically, the control unit 402 acts as a positional information management unit 4021, an operation command generation unit 4022, a need management unit 4023, and the like. Among them, the positional information management unit 4021 and the operation command generation unit 4022 perform processes relevant to the autonomous traveling of the movable body 100.

The positional information management unit 4021 and the operation command generation unit 4022 will be described. The positional information management unit 4021 collects positional information from a plurality of movable bodies 100 that is managed by the management server 400, and manages the positional information. Specifically, with a predetermined period, the positional information management unit 4021 receives current position information at the time point from the plurality of movable bodies 100, and stores the current position information in the movable body management DB 403 (table T1). Further, from each of a plurality of user terminals 60, the positional information management unit 4021 can collect information indicating the current position of the user, and can store the current position in the user management DB 404 (table T2).

The operation command generation unit 4022 determines the stop time at the base point and the next destination for the movable body 100, based on the schedule information and the information indicating the need (for example, the delivery request or the pickup request), and generates operation commands to give instructions of the stop at the base point and the movement to the next destination. The information about the next destination includes the information indicating the base point and the path to a delivery position or pickup position. The delivery position or pickup position described here means the delivery position or pickup position designated by the user in the delivery request or pickup request, and is different from the delivery position or pickup position as the service provision position (stoppable position) that is determined in response to the detection of the user by the movable body 100. The operation command generation unit 4022 receives a calculation request for the stoppable position about the user detected by the movable body 100, refers to the current position of the user and the stoppable positions of the stoppable position list 405, determines a stoppable position where the movable body 100 stops, generates an operation command in which the destination is the determined stoppable position. Then, the operation command generation unit 4022 gives the generated operation command to the movable body 100 by using the communication unit 401.

The need management unit 4023 performs, for example, a process to register the information indicating the need, which is received from the user terminal 60, in the user management DB 404, and a process to send the information indicating the need or the provision instruction for the service corresponding to the need, to the movable body 100, at an appropriate timing. The need management unit 4023 performs a process to send the information indicating the need or the provision instruction for the service corresponding to the need to the movable body 100 by using the communication unit 401.

The need management unit 4023 of the control unit 402 is an example of the acquisition means and supply means according to the disclosure. The operation command generation unit 4022 is an example of correspond to the movement control means according to the disclosure.

User Terminal

The user terminal 60 includes a communication unit 61, a control unit 62, an input-output unit 63, and a positional information acquisition unit 64. As the communication unit 61 and the control unit 62, the same kinds of devices as devices to be used for the communication unit 401 and control unit 402 of the management server 400 can be applied. The input-output unit 63 includes input devices (a button, a key, a pointing device, a touch panel, a microphone, and the like) and output devices (a display monitor, a speaker, and the like). The positional information acquisition unit 64 includes a GPS receiver that acquires the position of the user terminal 60.

The control unit 62 performs a process to accept the information indicating the need, which is input using the input-output unit 63, and send the information indicating the need to the management server 400 through the communication unit 61. The input of the information indicating the need may be a text input, may be a voice input, or may be a result of selection from options of the information indicating the need. The options of the information indicating the need are presented to the user through a user interface.

When the communication unit 61 receives the search signal for the user terminal 60, the control unit 62 can perform a process to generate the answer signal including the user ID and send the answer signal from the communication unit 61. Further, the control unit 62 performs a process to acquire the information corresponding to the need, which is sent from the movable body 100, through the communication unit 61, and display the information corresponding to the need, on the display monitor of the input-output unit 63.

Some of the constituent elements of the management server 400, the movable body 100 and the user terminal 60, or some of the processes may be executed by another computer that is connected to the network 1. Further, the processes to be performed by each of the control units of the management server 400, the movable body 100 and the user terminal 60 may be executed by software, or may be executed by hardware.

Exemplary Action

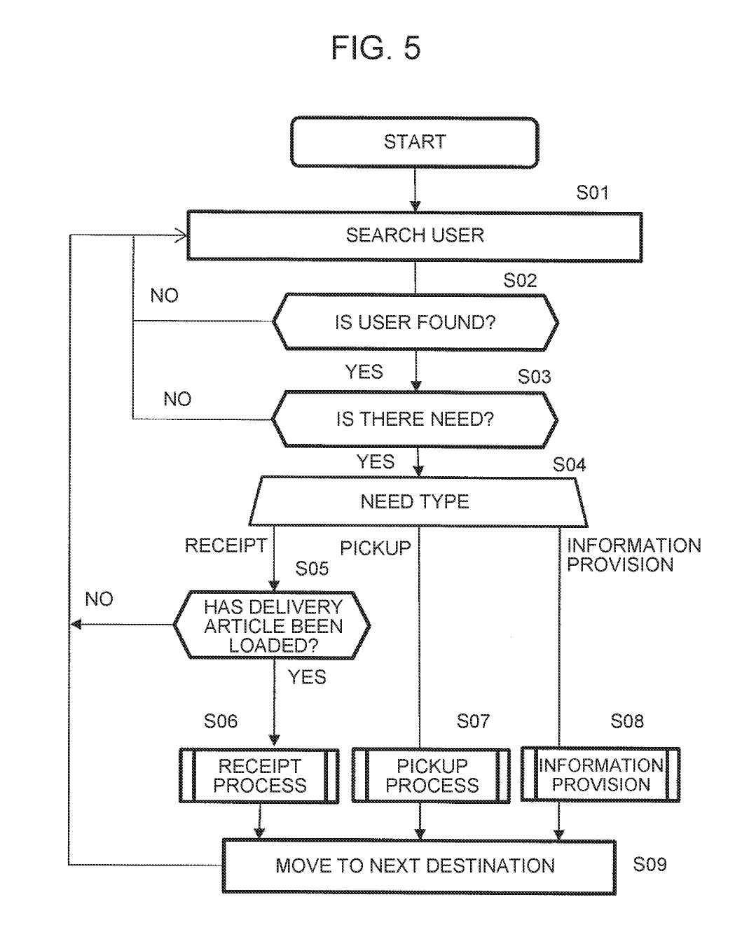

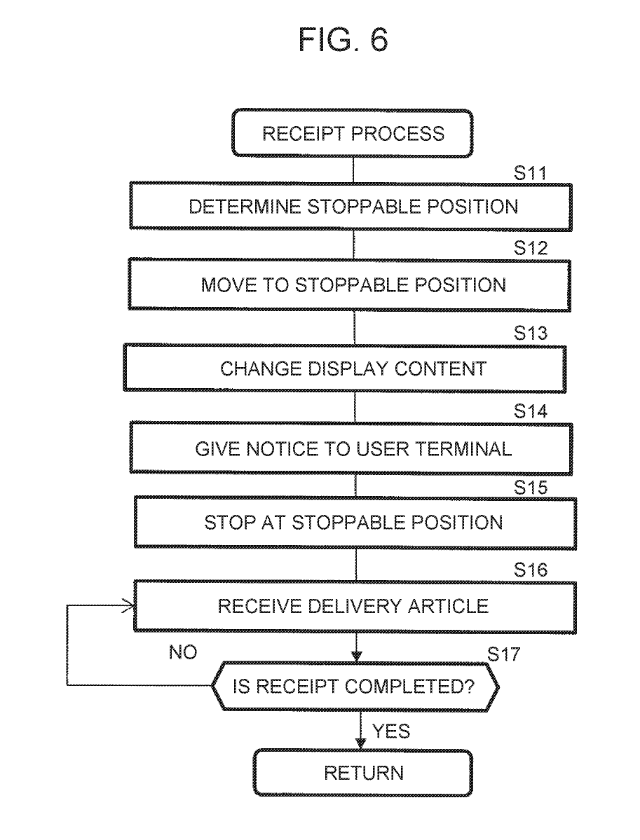

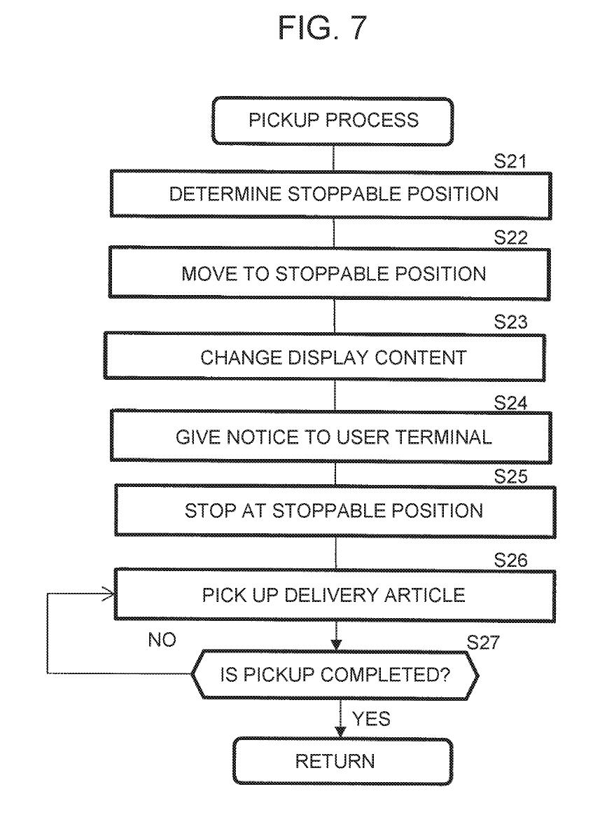

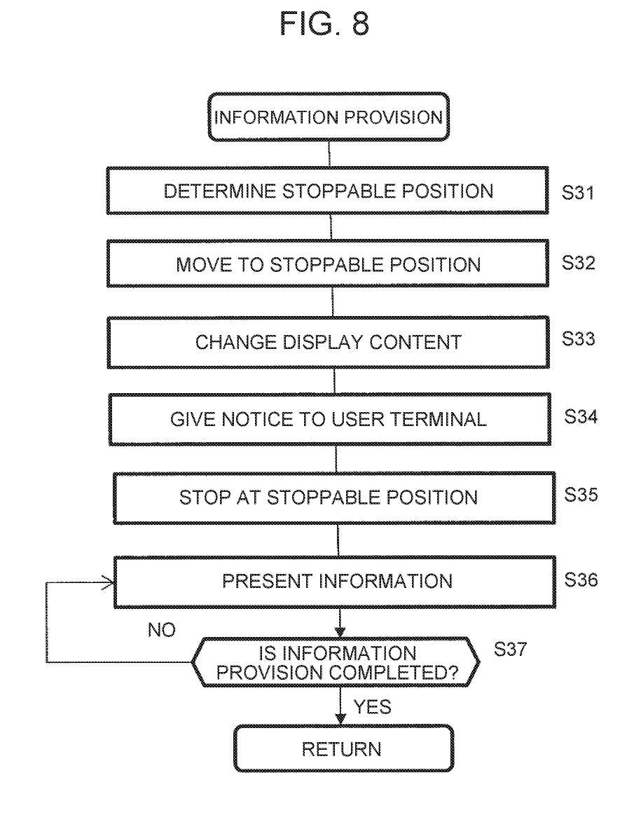

Hereinafter, exemplary processes in the service provision system will be described with use of FIG. 5, FIG. 6, FIG. 7 and FIG. 8. FIG. 5 is a flowchart showing an exemplary process of the movable body 100. FIG. 6 is a flowchart showing an example of a receipt process for the delivery article. FIG. 7 is a flowchart showing an example of a pickup process for the delivery article. FIG. 8 is a flowchart showing an exemplary process for the information provision of the information corresponding to the need.

The process of FIG. 5 is started at an appropriate timing in a period during which the movable body 100 is operating. The appropriate timing may be a timing when the movable body 100 is moving, or may be a timing when the movable body 100 is at a stop. In S01 of FIG. 5, the user search unit 1034 of the movable body 100 performs user search by using the camera 106. The user search is performed by the face recognition process using a face image contained in the image that is an image of the surround of the movable body 100 and that is photographed by the camera 106.

Specifically, the user search unit 1034 extracts the information indicating the features of the face, from the face image in the image photographed by the camera 106, performs comparison with the face information (the information indicating the features of the face of the user) acquired from the management server 400 together with the user ID, and determines whether the two pieces of information coincide with each other (S02). In the case where the two pieces of information coincide with each other, the user search unit 1034 detects the human with the face image as the user, and determines that the user exists in the periphery of the movable body 100. The user ID corresponding to the face information is regarded as the user ID of the user who exists in the periphery of the movable body 100. In the case where the two pieces of information do not coincide with each other, the user search unit 1034 determines that the user does not exist in the periphery of the movable body 100, returns the process to S01, and waits until the next search timing.

On the other hand, in the case where the user search unit 1034 determines that the user exists in the periphery of the movable body (Yes in S02), the need analysis unit 1035 inquires of the management server 400 about whether there is the need corresponding to the user ID, using the communication unit 105. The need management unit 4023 of the management server 400 refers to the table T2 of the user management DB 404, and determines whether there is the need corresponding to the user ID. In the case where there is not the need, the need management unit 4023 sends information indicating that there is not the need of the user (or information indicating that the user does not exist), to the movable body 100, using the communication unit 401. In the case where there is the need, the need management unit 4023 acquires the need type information corresponding to the need and the corresponding information from the table T2, and sends the acquired information to the movable body 100.

In the case where the need analysis unit 1035 receives the information indicating that there is not the need (or the information indicating that the user does not exist) (No in S03), the need analysis unit 1035 returns the process to S01. On the other hand, in the case where the need analysis unit 1035 receives the need type information and the corresponding information from the management server 400 (Yes in S03), the need analysis unit 1035 determines that there is the need, and advances the process to S04.

In S04, the need analysis unit 1035 determines the need type, using the need type information. In the example of FIG. 5, as the need type, the need analysis unit 1035 determines one of “RECEIPT” indicating the receipt of the delivery article, “PICKUP” indicating the pickup of the delivery article and “INFORMATION PROVISION” indicating the provision of the information corresponding to the need.

In the case where the need type is “RECEIPT”, the service provision processing unit 1036 sends an inquiry about the delivery article information corresponding to the user, to the management server 400. The control unit 402 of the management server 400 sends the content of the delivery article information in a record of the table T2, to the movable body 100. The record of the table 12 corresponds to the user ID included in the inquiry.

The service provision processing unit 1036 of the movable body 100 determines whether the delivery article to the user has been loaded on the movable body 100 itself, using the content of the delivery article information received from the management server 400 (S05). That is, in the case where the delivery article information does not include the movable body ID of the movable body 100 on which the delivery article has been loaded or in the case where the movable body ID in the delivery article information is different from its own movable body ID, the service provision processing unit 1036 determines that the delivery article has not been loaded, and returns the process to S01. On the other hand, in the case where the movable body ID coincides with its own movable body ID, the service provision processing unit 1036 advances the process to S06.

The management server 400 may determine whether the need type information is “RECEIPT”, and in the case of “RECEIPT”, the management server 400 may send the content of the delivery article information to the movable body 100, together with the need type information and the corresponding information. In this case, the movable body 100 does not need to send the inquiry about the delivery article information. In S06, the service provision processing unit 1036 executes the receipt process.

In the case where the service provision processing unit 1036 determines in S04 that the need type is “PICKUP”, the service provision processing unit 1036 executes the pickup process (S07). In the case where the service provision processing unit 1036 determines in S04 that the need type is “INFORMATION PROVISION”, the service provision processing unit 1036 executes the information provision process (S08).

By the receipt process, the pickup process or the information provision process, the receipt of the delivery article, the pickup of the delivery article or the provision of the information corresponding to the need is performed at the service provision position, as a result. When the process is completed, a notice of the completion of the process is given to the management server 400. In the management server 400, the need management unit 4023 updates the table T1 and the table T2. Further, the operation command generation unit 4022 sends the operation command indicating the movement to the next destination.

The movable body 100 receives the operation command, and starts to move to the next destination (S09). However, in some cases, in S09, the movable body 100 receives a command to wait at the base point until the movement start time, instead of the operation commend, so that the stop state is maintained until the movement start time.

The processes of S02 and S03 can be modified as follows. That is, the user search unit 1034 sends the face image information or the information indicating the features of the face extracted from the face image, to the management server 400, using the communication unit 105. The control unit 402 of the management server 400 performs face comparison, using the face information of the user that is stored in the user management DB 404 and the face image information or the information indicating the features of the face that is received from the movable body 100, and determines whether the information received from the movable body 100 coincides with the face information.

In the case where the information received from the movable body 100 does not coincide with the face information, the control unit 402 sends the information indicating that the user does not exist, to the movable body 100 through the communication unit 401. In the case where the information received from the movable body 100 coincides with the face information, the control unit 402 refers to the record (the record of the table T2) of the user corresponding to the face information, and determines whether there is the need. If the need is “NON-EXISTENCE”, the control unit 402 sends the information indicating that there is not the need of the user (or the information indicating that the user does not exist) to the movable body 100 through the communication unit 401. If the need is “EXISTENCE”, the control unit 402 acquires the need type information corresponding to the need and the corresponding information from the table T2, and sends the acquired information to the movable body 100. In this case, since the face recognition is not performed by the movable body 100, the processing load of the movable body 100 decreases.

Further, without inquiring of the management server 400, the need analysis unit 1035 may execute the processes of S03 and S04, for example, using the copy of the user management information that is stored in the local.

Receipt Process

In the subroutine of the receipt process shown in FIG. 6, the service provision processing unit 1036 determines the stoppable position, in S11. That is, the service provision processing unit 1036 sends a provision request for the stoppable position that includes the user ID, to the management server 400. The control unit 402 of the management server 400 refers to the record of the table T2 that corresponds to the user ID, refers to the current position of the user and the stoppable position list 405, and determines the stoppable position (service provision position: a position where the user receives the delivery article) of the movable body 100. The operation command generation unit 4022 generates an operation command to move the movable body 100 to the stoppable position, and the communication unit 401 sends the operation command to the movable body 100. As an example of the stoppable position, the stoppable position closest to the current position of the user is selected from the stoppable position list 405. The selection method for the stoppable position can be appropriately changed.

In the process of S11, the service provision processing unit 1036 of the movable body 100 may receive the current position of the user and the content of the stoppable position list 405, from the management server 400, may determine the stoppable position using the received information, and may request the issuance of the operation command corresponding to the stoppable position, to the management server 400.

In response to the operation command, the operation plan generation unit 1031, the traveling control unit 1033 and the drive unit 104 acts, and the movable body 100 moves to the stoppable position (service provision position) (S12). With the receiving of the operation command, the service provision processing unit 1036 changes the display content of the display monitor 107, to a content that includes the information indicating that the delivery article is being delivered (the information corresponding to the need) (S13). Thereby, the information corresponding to the need is output.

At the normal time, predetermined information such as an advertisement is displayed on the display monitor 107. However, at the normal time, the screen display of the display monitor 107 may be turned off. Further, the information indicating the stoppable position (for example, a map indicating the stoppable position) may be displayed on the display monitor 107, together with the information corresponding to the need.

In S14, the service provision processing unit 1036 sends (outputs) the information corresponding to the need and the information indicating the stoppable position to the user terminal 60, using the communication unit 105. The control unit 62 of the user terminal 60 displays the information corresponding to the need and the information indicating the stoppable position, on the display monitor of the input-output unit 63. By referring to the information indicating the stoppable position, the user can know that the user can receive the delivery article at the stoppable position.

Further, by referring to the display monitor 107 of the movable body 100, the user can identify the movable body 100 on which the delivery article has been loaded. Particularly, in an environment in which the user can visually recognize a plurality of movable bodies 100, the user can discriminate the movable body 100 on which the delivery article has been loaded, from the other movable bodies 100, based on the difference in display content. The display content of the display monitor 107 may include a character, figure or background color that can be distinguished by the user but cannot be distinguished by other persons, such that the identification can be performed. For example, the figure, text or background color constituting the display content may vary for each user, such that the user can discriminate the movable body 100 based on the display content even when delivery articles are being delivered by a plurality of movable bodies 100.

When the movable body 100 arrives at the stoppable position, the movable body 100 stops at the stoppable position (S15). The user comes close to the movable body 100 stopped at the stoppable position, and receives the delivery article (S16). That is, the user inputs an unlock code (password number) to a touch panel that is provided on a cover (lid) of the loading place (storing space) for the delivery article. For example, the cover is locked by an unillustrated electromagnetic key, and is unlocked by the input of the proper unlock code. For example, the unlock code may be included in the information that is sent to the user terminal 60 in S14. However, the unlock code may be transmitted to the user by another method (for example, by e-mail). After the unlocking, the user opens the cover, and takes the delivery article from the loading place. Thereafter, the user returns the cover to a predetermined closing position, and thereby, the electromagnetic key is actuated, so that the cover is locked. The locking is used as a trigger indicating the completion of the receipt of the delivery article (Yes in S17). By this trigger, the receipt process is completed, and information indicating the completion of the receipt is sent to the management server 400. Thereafter, the process proceeds to S09 (FIG. 5).

The need management unit 4023 of the management server 400 updates the need for the user to “NON-EXISTENCE”, and removes the need type information, the corresponding information and the delivery article information, from the table T2. Further, in connection with the above-described process of S09, the need management unit 4023 changes the status in the table T1 based on the operation command for the next destination, updates the existence or non-existence of the delivery article in the table T1, to “NON-EXISTENCE”, and removes the delivery article information and the user ID. The processes of S13 and S14 may be performed in reverse order. One of the processes of S13 and S14 may be omitted. The same goes for the processes of S23 and S24 and the processes of S33 and S34, which will be described later.

Pickup Process

In the subroutine of the pickup process in FIG. 7, the processes of S21 to S27 are nearly the same as the processes of S11 to S17. However, there are differences described below. In S21, the service provision processing unit 1036 determines the stoppable position as the service provision position (a position where the delivery article is loaded on the movable body 100). The process of S22 is the same as the process of S12.

In S23, the service provision processing unit 1036 changes the display content of the display monitor 107, to a content that includes the information indicating that the movable body 100 is on the way for the pickup of the delivery article (the information corresponding to the need). Thereby, the information corresponding to the need is output. The process of S24 is the same as the process of S14. After S24, by referring to the information indicating the stoppable position, the user can know that the user can load the delivery article on the movable body 100 at the stoppable position.

The process of S25 is the same as the process of S15. The user comes close to the movable body 100 stopped at the stoppable position, and loads the delivery article (S26). That is, the user inputs an unlock code (password number) to a touch panel that is provided on the cover (lid) of the loading place (storing space) for the delivery article. For example, the unlock code is included in the information that is sent to the user terminal 60 in S24. After the unlocking, the user opens the cover, and puts the delivery article on the loading place. Thereafter, the user returns the cover to the predetermined closing position, and thereby, the electromagnetic key is actuated, so that the cover is locked. The locking is used as a trigger indicating the completion of the pickup of the delivery article (Yes in S27). By this trigger, the pickup process is completed, and information indicating the completion of the pickup is sent to the management server 400. Thereafter, the process proceeds to S09 (FIG. 5).

The need management unit 4023 of the management server 400 updates the need for the user to “NON-EXISTENCE”, and removes the need type information and the corresponding information, from the table T2. Further, in connection with the above-described process of S09, the need management unit 4023 changes the status in the table T1 based on the operation command for the next destination. The modifications described for the receipt process can be applied also to the pickup process. The delivery business operator collects the picked-up delivery article from the movable body 100, and performs the transport to the destination, and the like.

Information Provision

In the subroutine of the information provision in FIG. 8, the processes of S31 to S37 are nearly the same as the processes of S11 to S17. However, there are differences described below. In S31, the service provision processing unit 1036 determines the stoppable position as the service provision position (a position where the movable body 100 presents, to the user, information indicating a path to a facility (for example, the movable body 100 (see FIG. 3) with a movable body ID “005” or a fixed shop) to sell a product (for example, pizza) that the user wishes to purchase). The process of S32 is the same as the process of S12.

In S33, the service provision processing unit 1036 changes the display content of the display monitor 107, to a content that includes the information indicating the path to the facility (shop) to sell the product that the user wishes to acquire (the information corresponding to the need). Thereby, the information corresponding to the need is output. The process of S34 is the same as the process of S14. After S34, by referring to the information indicating the stoppable position, the user can know that the user can receive the presentation of the information indicating the path to the facility (shop) at the stoppable position. When the user receives the presentation of the information at the stoppable position, the user can obtain easily-viewable information on a larger screen than when the user refers to the user terminal 60.

The process of S35 is the same as the process of S15. The user comes close to the movable body 100 stopped at the stoppable position, and refers to the information presented by the display on the display monitor 107 (S36). For example, the display monitor 107 includes a touch panel, and by operation of the touch panel, the user can display further detailed information on the display monitor 107, or can perform retrieval using a search engine and can display the result on the display monitor 107.

When the user finishes to read the information, the user presses a completion button that is displayed on the display monitor 107. The press of the completion button triggers completion of the information provision, so that the process in FIG. 8 is completed (Yes in S37). By this trigger, the information provision process is completed, and information indicating the completion of the information provision is sent to the management server 400. Thereafter, the process proceeds to S09 (FIG. 5).

The need management unit 4023 of the management server 400 updates the need for the user to “NON-EXISTENCE”, and removes the need type information and the corresponding information, from the table T2. Further, in connection with the above-described process of S09, the need management unit 4023 changes the status in the table T1 based on the operation command for the next destination. The modifications described for the receipt process can be applied also to the information provision process.

### EFFECTS OF EMBODIMENT

With the embodiment, when the movable body 100 detects the user during the stop or during the movement, the movable body 100 can output the information corresponding to the need of the user, to the display monitor 107 or the user terminal 60, and can give the notice of the information corresponding to the need, to the user. Thereby, the user can easily receive the provision of the service corresponding to the need, using the movable body 100. The user receives the information indicating the stoppable position (service provision position) of the movable body 100, and goes to the stoppable position. Thereby, the user can receive the provision of the service corresponding to the need (the receipt of the delivery article, the pickup of the delivery article (the loading of the delivery article on the movable body 100), the presentation of information (the guide to a facility where the user can purchase a product), and the like). In the information provision, the movable body 100 functions as a movable guide plate, and thereby, the user can arrive at the facility without getting lost. The facility can include, for example, facilities (hospitals, stations, athletic facilities, temples, shrines, art museums, museums, and libraries) other than shops, business offices and business sites. Constituents of the embodiment described above can be appropriately combined without departing from the object of the disclosure.

What is claimed is:

1. A movable body that provides a service to a user, the movable body comprising:
a detection unit configured to detect the user who exists in a periphery of the movable body;
an acquisition unit configured to acquire first information indicating a need of the user; and
an output unit configured to output second information corresponding to the need.

2. The movable body according to claim 1, wherein the output unit is configured to output information indicating that an article has been loaded on the movable body, as the second information, when the first information indicates receipt of the article and the article has been loaded on the movable body.

3. The movable body according to claim 1, wherein the output unit is configured to output information indicating that an article is able to be picked up, as the second information, when the first information indicates pickup of the article.

4. The movable body according to claim 1, wherein the output unit is configured to output information by which the user is guided to a facility which is able to provide a predetermined service to the user, as the second information, when the first information indicates a demand for the predetermined service.

5. The movable body according to claim 1, wherein the output unit includes a display device configured to display the second information, the display device existing at a position that allows the display device to be visually recognized from an outside of the movable body.

6. The movable body according to claim 1, wherein the output unit includes a communication unit configured to send the second information to a terminal of the user.

7. The movable body according to claim 1, further comprising a movement control unit configured to move the movable body to a position where the service is provided to the user.

8. A service providing method of a movable body that provides a service to a user comprising:
detecting the user who exists in a periphery of the movable body;
acquiring first information indicating a need of the user, and
outputting second information corresponding to the need.

9. A computer-readable non-transitory storage medium in which a program is stored, wherein the program makes a computer of a movable body that provides a service to a user, execute:
detecting the user who exists in a periphery of the movable body;
acquiring first information indicating a need of the user; and
outputting second information corresponding to the need.

10. A service providing system comprising:
a movable body able to provide a service corresponding to a need of a user; and
a management device for the movable body, wherein:
the management device includes
acquisition means configured to acquire first information indicating the need of the user, and
supply means configured to supply the first information to the movable body; and
the movable body includes
a detection unit configured to detect the user who exists in a periphery of the movable body,
an acquisition unit configured to acquire the first information from the management device, and
an output unit configured to output second information corresponding to the need.

11. The service providing system according to claim 10, wherein the management device further includes movement control means configured to send a signal to the movable body that provides the service corresponding to the need, the signal indicating an instruction of movement of the movable body to a stoppable position.
